(19) United States
(12) Patent Application Publication
(10) Pub. No.: US 2024/0288038 A1
(43) Pub. Date: Aug. 29, 2024

(54) BRAKE ASSEMBLY

(71) Applicant: DANA ITALIA S.R.L., Arco (IT)

(72) Inventors: Gianluca TERRASI, Arco (IT); Davide DEIMICHEI, Trento (IT); Simone TRAPLETTI, Riva del Garda (IT); Jarret DAVIS, Whitehouse, OH (US)

(21) Appl. No.: 18/589,266

(22) Filed: Feb. 27, 2024

(30) Foreign Application Priority Data
Feb. 28, 2023 (DE) 20 2023 100 938.7

(51) Int. Cl. F16D 55/40; F16D 121/04; F16D 121/20

(52) U.S. Cl. CPC F16D 55/40; F16D 2121/04; F16D 2121/20

(57) ABSTRACT

The present disclosure relates to a brake assembly comprising a stationary portion forming a hollow for receiving a brake pack therein, and a stop member partially received in or configured to be partially received in the hollow along an axis to form a brake pack stop, wherein the stop member has a plurality of axially spaced coupling features for selectively coupling the stop member to the stationary portion at either one of two or more different axial positions of the stop member relative to the stationary portion.

### CROSS-REFERENCE TO RELATED APPLICATION

The present application claims priority to German Utility Model Application No. 20 2023 100 938.7, entitled “BRAKE ASSEMBLY”, and filed Feb. 28, 2023. The entire contents of the above-listed application is hereby incorporated by reference for all purposes.

### TECHNICAL FIELD

The present disclosure relates to a brake assembly such as for an automotive vehicle.

### BACKGROUND AND SUMMARY

Brake assemblies typically include a brake pack comprising one or more stator plates coupled to a stationary portion such as an axle housing, and one or more rotor plates coupled to a rotatable shaft to be braked. Usually, the brake assembly further includes a brake piston which may selectively compress the brake pack to apply a brake torque on the rotor plates or on the rotatable shaft coupled to the rotor plates. The number of stator plates and/or rotor plates included in a brake pack may vary depending on a maximum brake torque to be applied to the rotatable shaft and/or depending on a space available for the brake pack.

For instance, it would be advantageous if a brake assembly could be adapted to brake packs including different numbers of stator plates and/or rotor plates. In this way, the same brake assembly could be installed on vehicles of different size and/or of different mass, for example. In brake assemblies known from the prior art, changing the number of stator plates and/or rotor plates usually requires a complex disassembly and re-assembly procedure and/or the exchange of other parts of the brake assembly.

Thus, there is demand for a brake assembly which may be more easily adapted to brake packs of different sizes.

This demand is met by a brake assembly including the features as described herein.

The presently proposed brake assembly comprises:
a stationary portion forming a hollow for receiving a brake pack therein, and
a stop member partially received in or configured to be partially received in the hollow along an axis to form a brake pack stop,
wherein the stop member has a plurality of axially spaced coupling features for selectively coupling or securing the stop member to the stationary portion at either one of two or more different axial positions of the stop member relative to the stationary portion.

Since the coupling features may couple or axially couple the stop member to the stationary portion, for example at least along the axis, at either one of two or more different axial positions relative to the stationary portion, the brake assembly can be easily adapted to brake packs of different axial thickness or axial extent. This may significantly reduce production costs and/or maintenance costs, for example.

The stop member may be a sleeve-like member. The plurality of coupling features of the stop member may be disposed on a radially outer side of the stop member. The stop member may be coupled to the stationary portion in a torque proof manner with respect to the axis, for example by means of a plurality of radially extending protrusions of the stop member received in axially extending recesses formed in a radially inner surface of the stationary portion, wherein radial directions are directions perpendicular to the axis. The radially extending protrusions of the stop member may be axially spaced from the coupling features of the stop member. For instance, at least one or more of the plurality of coupling features of the stop member may protrude out of the hollow of the stationary portion.

The brake assembly may further comprise a brake pack received in the hollow of the stationary portion. Typically, the brake pack includes one or more stator plates coupled to the stationary portion and one or more rotor plates configured to be coupled to a rotatable shaft. For example, the one or more stator plates may be coupled to the stationary portion in a torque proof manner, such as via a splined connection between the one or more stator plates and the stationary portion, allowing the stator plates to move or slide relative to the stationary portion along the axis. Similarly, the one or more rotor plates may be coupled to the rotatable shaft in a torque proof manner, such as via a splined connection between the one or more rotor plates and the rotatable shaft, allowing the one or more rotor plates to move or slide relative to the rotatable shaft along the axis.

The brake assembly may further comprise a brake piston for selectively pressing the brake pack against the stop member along the axis. The brake pack is then usually disposed in between the brake piston and the stop member along the axis.

The brake assembly may further comprise a coupling assembly secured to the stationary portion. The stop member may then be configured to be selectively coupled to the coupling assembly via cither one of the plurality of axially spaced coupling features. Or in other words, the stop member may be coupled or secured to the stationary portion via the coupling assembly.

The coupling assembly may include a cover member secured to the stationary portion. For example, the brake assembly may include a plurality of fasteners securing the cover member to the stationary portion. The fasteners may include screws, bolts, or the like. The coupling assembly may further include a coupling member mounted on the cover member. The stop member may then be configured to be selectively axially coupled or secured to the cover member via either one of the plurality of axially spaced coupling features. The cover member may couple or secure the coupling member to the stationary portion. The coupling member may be mounted in a recess formed on a radially inner side of the cover member.

The plurality of axially spaced coupling features of the stop member may include a plurality of axially spaced annular grooves formed in a radially outer surface of the stop member. The coupling member may then be selectively received in either one of the plurality of axially spaced annular grooves. For example, the coupling assembly may include a snap ring received in or configured to be received in either one of the plurality of axially spaced annular grooves of the stop member. For example, the coupling member of the coupling assembly may include or may be configured as said snap ring. In this way, an axial position of the stop member relative to the stationary portion may be altered by engaging the snap ring with different ones of the axially spaced annular grooves of the stop member. For instance, the plurality of axially spaced annular grooves may be periodically arranged along the axis. A period length of the plurality of axially spaced annular grooves may then correspond to a sum of an axial thickness of one of the stator plates and of one of the rotor plates.

Additionally or alternatively, the plurality of axially spaced coupling features of the stop member may include a male threaded portion formed in a radially outer surface of the stop member. The coupling assembly may then include a female threaded portion engaged with or configured to be engaged with the male threaded portion of the stop member. For instance, the female threaded portion may be formed in a radially inner surface of the coupling member. For example, the coupling member may be or may include a nut. In this way, an axial position of the stop member relative to the stationary portion may be altered by moving the threads of the female threaded portion of the coupling assembly or of the coupling member along the threads of the male threaded portion of the stop member, or vice versa.

In the following, embodiments of the presently proposed brake assembly are described with reference to the figures.

### BRIEF DESCRIPTION OF THE FIGURES

FIG. 1A schematically shows a section of a brake assembly including a stationary portion and a stop member according to a first embodiment.

FIG. 1B schematically shows a top view of the brake assembly of FIG. 1A.

FIG. 1C schematically shows a perspective view of the brake assembly of FIGS. 1A-B.

FIG. 1D schematically shows a perspective view of a stop member of the brake assembly of FIGS. 1A-C.

FIG. 1E schematically shows a sectional view of the brake assembly of FIGS. 1A-C, wherein the stop member is disposed at a first axial position relative to the stationary portion.

FIG. 1F schematically shows a sectional view of the brake assembly of FIGS. 1A-C, wherein the stop member is disposed at a second axial position relative to the stationary portion.

FIG. 1G schematically shows a sectional view of the brake assembly of FIGS. 1A-C, wherein the stop member is disposed at a third axial position relative to the stationary portion.

FIG. 2A schematically shows a section of a brake assembly according to a second embodiment.

FIG. 2B schematically shows a top view of the brake assembly of FIG. 2A.

FIG. 2C schematically shows a perspective view of the brake assembly of FIGS. 2A-B.

FIG. 2D schematically shows a perspective view of a stop member of the brake assembly of FIGS. 2A-C.

FIG. 2E schematically shows a sectional view of the brake assembly of FIGS. 2A-C, wherein the stop member is disposed at a first axial position relative to the stationary portion.

FIG. 2F schematically shows a sectional view of the brake assembly of FIGS. 2A-C, wherein the stop member is disposed at a second axial position relative to the stationary portion.

FIG. 2G schematically shows a sectional view of the brake assembly of FIGS. 2A-C, wherein the stop member is disposed at a third axial position relative to the stationary portion.

### DETAILED DESCRIPTION

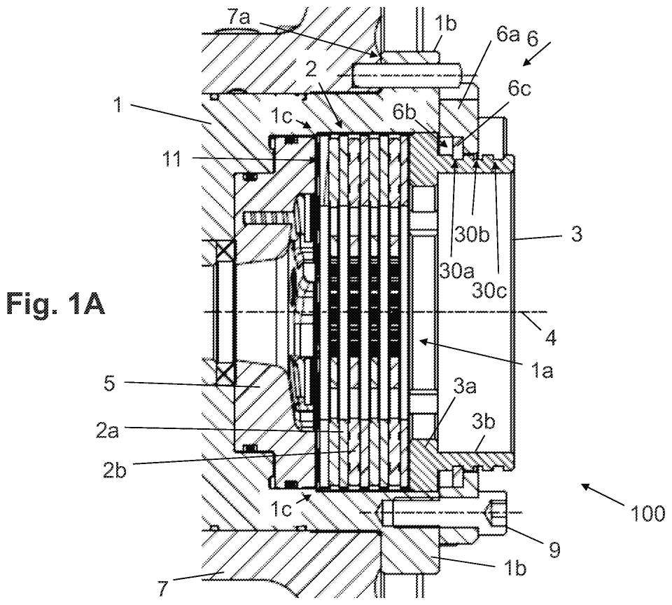

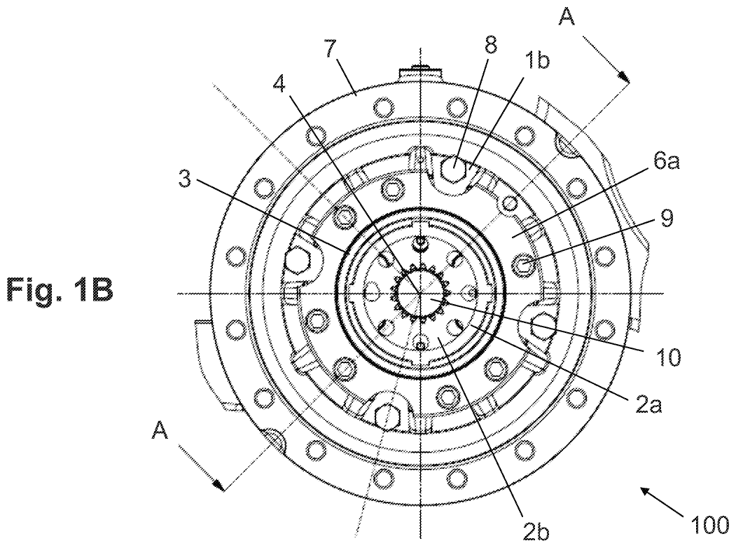

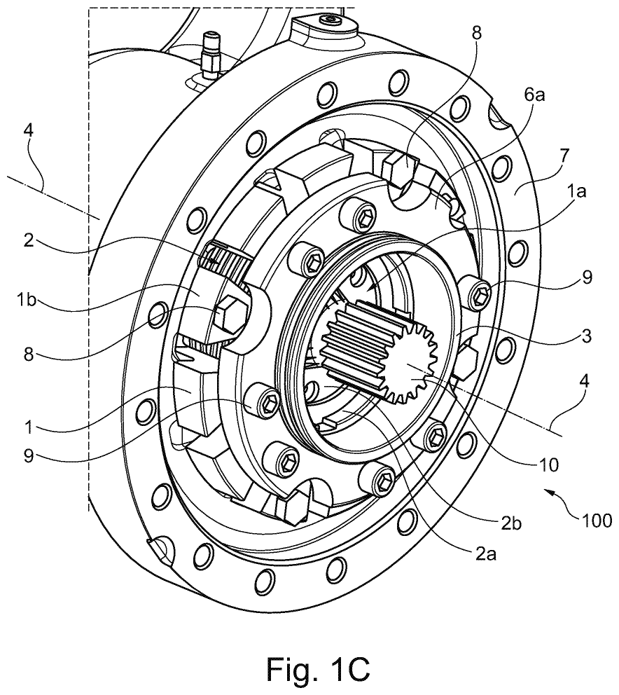

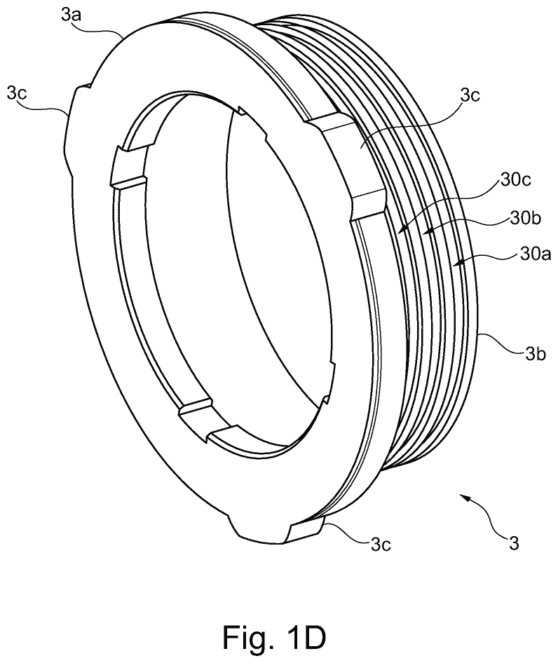

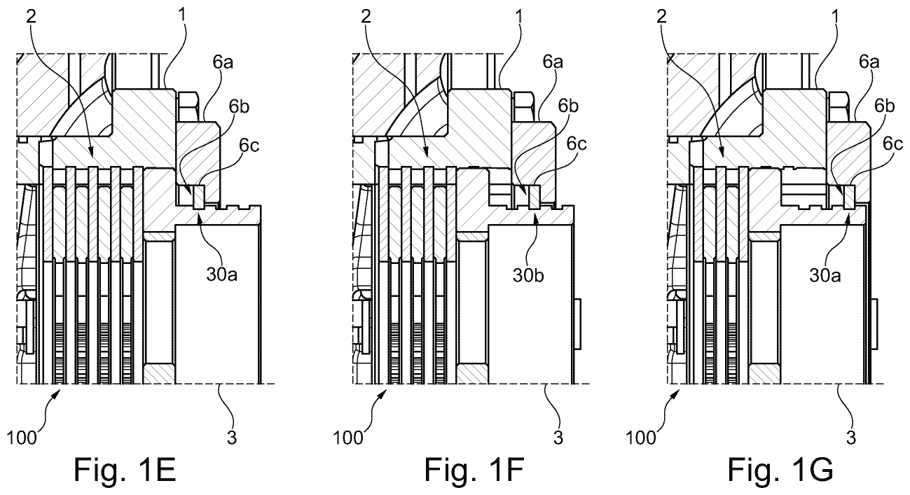

FIGS. 1A-C schematically show a brake assembly 100 including a stationary portion 1 and a stop member 3. In FIG. 1B, the sectional plane of FIG. 1A is indicated by a line marked A-A. A perspective view of the stop member 3 of the brake assembly 100 is depicted in FIG. 1D. And FIGS. 1E-G schematically show the brake assembly 100 of FIGS. 1A-C with the stop member 3 in different axial positions relative to the stationary portion 1. Here and in all of the following, features recurring in different figures are designated with the same reference signs.

In the embodiment of the brake assembly of FIGS. 1A-G, the stationary portion 1 has a cartridge-like shape. One or both of the stationary portion 1 and the stop member 3 may be rotationally symmetric or essentially rotationally symmetric with respect to an axis 4. The stationary portion 1 forms a hollow 1a. The hollow 1a is open on one side along the axis 4, thereby allowing the stop member 3 to be inserted into the hollow 1a along the axis 4. The stop member 3 includes an annular stop portion 3a and a sleeve portion 3b extending from the stop portion 3a along the axis 4. The stop portion 3a and the sleeve portion 3b may be formed in one piece. The stop member 3 is partially received in the hollow 1a along the axis 4. More specifically, the stop portion 3a of the stop member 3 is received in the hollow 1a formed by the stationary portion 1 while the sleeve portion 3b protrudes or at least partially protrudes out of the hollow 1a along the axis 4.

In the embodiment of the brake assembly 100 depicted in the figures, the stationary portion 1 is partially received in an axle housing 7. The stationary portion 1 has flanges 1b which protrude out of the axle housing 7. The flanges 1b extend radially outward and away from the axis 4 and abut a radially extending portion 7a of the axle housing 7. For example, the stationary portion 1 may be secured to the axle housing 7 by means of fasteners 8, see FIGS. 1B and 1C. The fasteners 8 may include screws, bolts, or the like. For example, the fasteners 8 may extend in parallel to the axis 4 and through the flanges 1b of the stationary portion 1, as indicated in FIGS. 1B and 1C.

The brake assembly 100 further includes a brake pack 2 disposed in the hollow 1a formed by the stationary portion 1. The brake pack 2 may be rotationally symmetric with respect to the axis 4. The brake pack 2 includes a plurality of stator plates 2a and a plurality of rotor plates 2b. The stator plates 2a and the rotor plates 2b extend perpendicular to the axis 4 and are alternatingly stacked along the axis 4. The plates 2a, 2b each have an annular shape so that a rotatable shaft 10 shown in FIGS. 1B and 1C may extend through the brake pack 2 along the axis 4. The axis 4 coincides with a rotation axis of the rotatable shaft 10. For illustrative purposes only, the rotatable shaft 10 is not shown in FIG. 1A.

The stator plates 2a are coupled to the stationary portion 1 in a torque proof manner with respect to the axis 4. For instance, the stator plates 2a may be coupled to the stationary portion 1 via a splined connection. More specifically, each of the stator plates 2a may have a radially outer rim with a toothed profile in engagement with axially extending splines formed in a radially inner surface of the stationary portion 1, wherein the radially outer rim of the stator plates 2a faces away from the axis 4 and the radially inner surface of the stationary portion 1 faces the axis 4. In this way, the stator plates 2a may move or slide relative to the stationary portion 1 along the axis 4.

Similarly, each of the rotor plates 2b may be coupled to the rotatable shaft 10 extending through the brake pack 2 in a torque proof manner, for example via a splined connection. More specifically, each of the rotor plates 2b may have a radially inner rim with a toothed profile in engagement with axially extending splines formed in an outer surface of the rotatable shaft 10, wherein the radially inner rim of the rotor plates 2b faces the axis 4. In this way, the rotor plates 2b may move or slide on the rotatable shaft 10 along the axis 4.

The brake assembly 100 further includes a brake piston 5. Here, the brake piston 5 is disposed in the hollow 1a formed by the stationary portion 1. Along the axis 4, the brake pack 2 is disposed in between the brake piston 5 and the stop member 3. The brake piston 5 is configured to be moved along the axis 4. The stop member 3, or, more specifically, the stop portion 3a of the stop member 3, functions as a stop for the brake pack 2. Or in other words, the stop portion 3 limits movement of the brake pack 2 in a direction along the axis 4 pointing from the brake piston 5 toward the stop member 3. That is, the brake piston 5 may push the brake pack 2 against the stop member 3 along the axis 4, thereby compressing the plates 2a, 2b of the brake pack 2 along the axis 4 in order to exert a brake torque on the rotor plates 2b and/or on the rotatable shaft 10 to which the rotor plates 2b are coupled. The brake piston 5 may be configured to be actuated by hydraulic forces or by electromagnetic forces, for example. A shoulder portion 1c formed on a radially inner side of the stationary portion 1 functions as another mechanical stop for the brake pack 2. Or in other words, the shoulder portion 1c limits movement of the brake pack 2 in a direction along the axis 4 pointing from the stop member 3 towards the brake piston 5.

As can be seen in FIG. 1A, an axial position of the stop member 3 relative to the stationary portion 1 determines a maximum axial thickness or a maximum axial extent of the brake pack 2. Also, the axial position of the stop member 3 relative to the stationary portion 1 determines an axial width of a gap 11 formed in between the brake piston 5 and the brake pack 2 when the brake piston 5 is in a non-braking or retracted position. For example, the axial width of said gap determines how fast and/or how strongly the rotatable shaft 10 is braked when an operator actuates the brake piston 5, such as by pressing a brake pedal.

The stop member 3 may be coupled to the stationary portion 1 in a torque proof manner with respect to the axis 4. For instance, the stop member 3 may include a plurality of protrusions 3c, see for example FIG. 1D, which extend radially outwardly from the stop portion 3a. The protrusions 3c may be received in correspondingly shaped axially extending recesses formed in a radially inner surface of the stationary portion 1, wherein the radially inner surface of the stationary portion 1 faces the axis 4.

Along the axis 4, the stop member 3 is axially coupled or secured to the stationary portion 1 by means of a coupling assembly 6. In the embodiment of the brake assembly 100 depicted in the figures, the coupling assembly 6 includes a cover member 6a and a coupling member 6c. The cover member 6a has an annular shape and is secured to the stationary portion 1 via a plurality of fasteners 9. For example, the fasteners 9 may extend in parallel to the axis 4 and through the cover member 6a. The fasteners 9 may include screws, bolts, or the like.

In the embodiment of the brake assembly 100 illustrated in the figures, the coupling member 6c is a snap ring mounted on the cover member 6a. More specifically, the coupling member 6c is received in a recess 6b formed in a radially inner side or in a radially inner surface of the cover member 6a. For example, the coupling member 6c may be mounted on the cover member 6a or in the recess 6b formed by the cover member 6a in a press-fit. As illustrated in FIG. 1A, the recess 6b may be open toward the brake pack 2 or toward the brake piston 5 along the axis 4. This may facilitate assembly in that it may allow sliding the cover member 6a over the stop member 3 and the coupling member 6c after the coupling member 6c has been coupled to or has been engaged with the stop member 3. In a radial direction perpendicular to the axis 4, the coupling member 6c protrudes out of the recess 6b and towards the axis 4. Or in other words, an inner radius of the annular coupling member 6b is smaller than a smallest inner radius of the cover member 6a. The cover member 6a limits movement of the coupling member 6c along the axis 4, for example at least in a direction along the axis 4 pointing from the brake piston 5 toward the stop member 3.

In order to allow the axial position of the stop member 3 relative to the stationary portion 1 to be adapted to a varying axial thickness of the brake pack 2, the stop member 3 has a plurality of axially spaced coupling features each of which may be engaged with the coupling member 6c. In the embodiment of the brake assembly 100 illustrated in the figures, the coupling features include three axially spaced annular grooves 30a-c. The annular grooves 30a-c are formed in a radially outer surface of the stop member 3. More specifically, the annular grooves 30a-c are formed in a radially outer surface of the sleeve portion 3b of the stop member 3. Along the axis 4, the annular grooves 30a-c are spaced from the stop portion 3a of the stop member 3 and from the protrusions 3c extending from the stop portion 3a. An axial width of each of the annular grooves 30a-c corresponds to or is just slightly greater than an axial width of the coupling member 6c so that the coupling member 6c may be received in each of the annular grooves 30a-c. When the coupling member 6c is received in one of the annular grooves 30a-c, the coupling member 6c is axially fixed relative to the stop member 3 and the cover member 6a limits axial movement of the stop member 3 relative to the stationary portion 1, for example at least in a direction along the axis 4 pointing from the brake piston 5 toward the stop member 3.

FIGS. 1E-G illustrate how the axial position of the stop member 3 relative to the stationary portion 1 can be altered by engaging the coupling member 6c, here given by a snap ring, with the different axially spaced annular grooves 30a-c of the stop member 3 in order to adapt the axial position of the stop member 3 relative to the stationary portion 1 to different thicknesses of the brake pack 2. Specifically, the axially spaced annular grooves 30a-c of the stop member 3 are periodically arranged along the axis 4. A period length of the periodically arranged annular grooves 30a-c corresponds to a sum of an axial thickness of one of the stator plates 2a and of one of the rotor plates 2b.

In FIG. 1E the brake pack 2 includes five stator plates and four rotor plates, the coupling member 6c is engaged with the left most annular groove 30a, and the stop member 3 is disposed at a first axial position relative to the stationary portion 1. In FIG. 1F the brake pack 2 includes four stator plates and three rotor plates, i. e. its axial thickness is reduced with respect to the axial thickness of the brake pack 2 of FIG. 1E, the coupling member 6c is engaged with the central annular groove 30b, and the stop member 3 is disposed at a second axial position relative to the stationary portion 1, further towards the brake piston 5 than in the first axial position of FIG. 1E. And in FIG. 1G the brake pack 2 includes three stator plates and two rotor plates, i. e. its axial thickness is further reduced with respect to the axial thickness of the brake pack 2 of FIG. 1F, the coupling member 6c is engaged with the right most annular groove 30c, and the stop member 3 is disposed at a third axial position relative to the stationary portion 1, still further towards the brake piston 5 than in the second axial position of FIG. 1F.

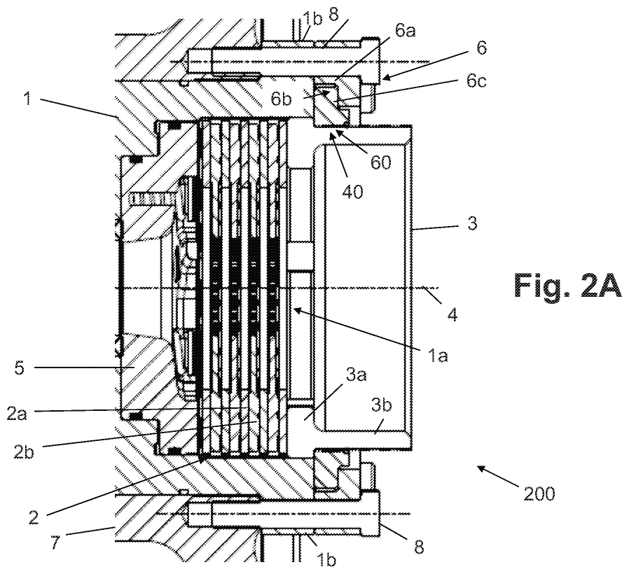

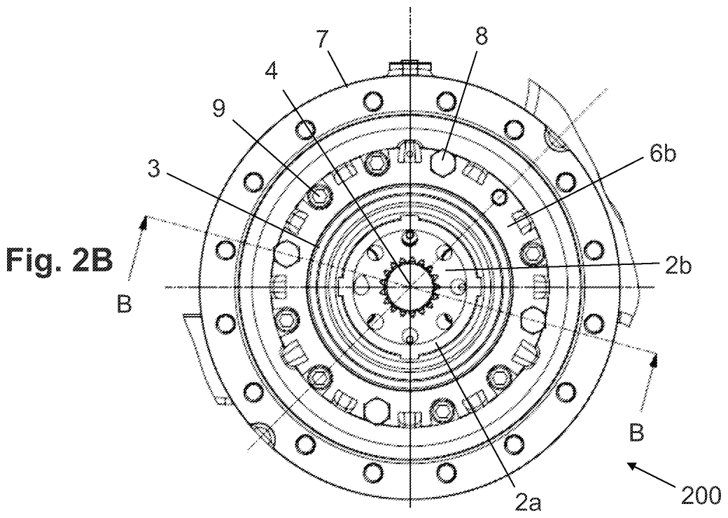

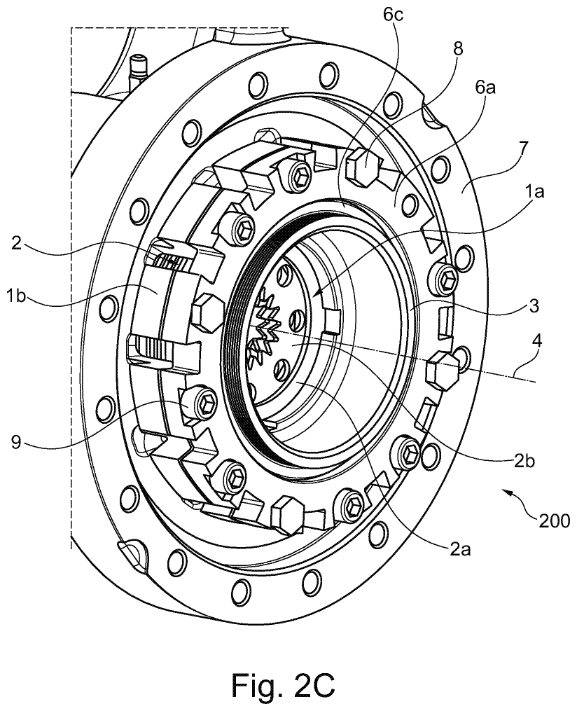

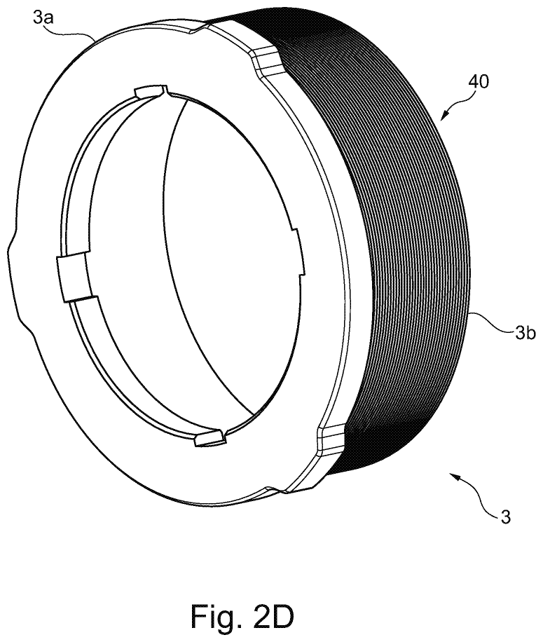

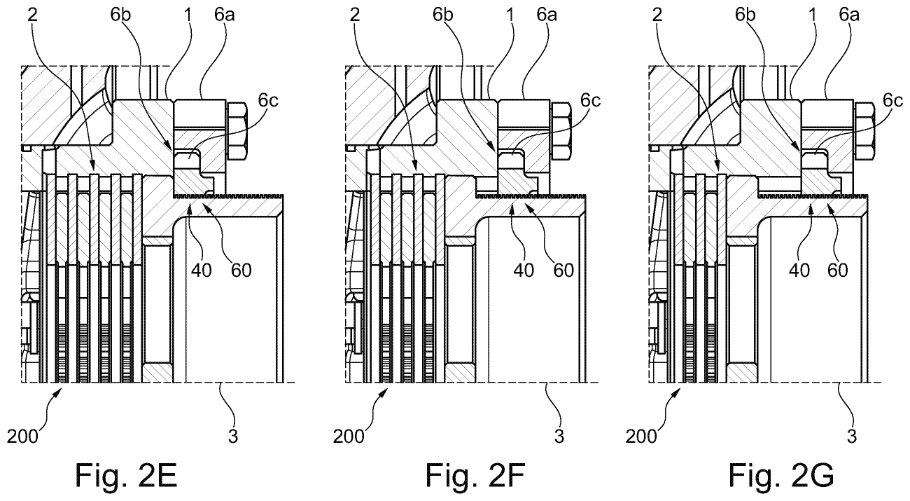

FIGS. 2A-C schematically show a brake assembly 200 including a stationary portion 1 and a stop member 3. In FIG. 2B, the sectional plane of FIG. 2A is indicated by a line marked B-B. A perspective view of the stop member 3 of the brake assembly 200 is depicted in FIG. 2D. And FIGS. 2E-G schematically show the brake assembly 200 of FIGS. 2A-C with the stop member 3 in different axial positions relative to the stationary portion 1. As before, features recurring in different figures are designated with the same reference signs.

The brake assembly 200 of FIGS. 2A-G is a variant of the brake assembly 100 of FIGS. 1A-G. Therefore, for matters of brevity and simplicity, in the following only those features of the brake assembly 200 of FIGS. 2A-G which distinguish it from the brake assembly 100 of FIGS. 1A-G are described in some detail. Unless explicitly stated to the contrary, the brake assembly 200 of FIGS. 2A-G may include the same features as the brake assembly 100 of FIGS. 1A-G.

The brake assembly 200 of FIGS. 2A-G differs from the brake assembly 100 of FIGS. 1A-G in that in the brake assembly 200 of FIGS. 2A-G the coupling features formed in the radially outer surface of the sleeve portion 3b of the stop member 3 include a male threaded portion 40, and the coupling member 6c is a nut having a female threaded portion 60 threadedly engaged with or configured to be threadedly engaged with the male threaded portion 40 of the stop member 3. That is, in the brake assembly 200 of FIGS. 2A-G the axial position of the stop member 3 relative to the stationary portion 1 can be altered by moving or screwing the threads of the female threaded portion 60 of the coupling member 6c along the threads of the male threaded portion 40 of the stop member 3, or vice versa.

Also, in the brake assembly 200 of FIGS. 2A-G the coupling member 6c is disposed in between the stationary portion 1 and the cover member 6b along the axis 4, and the cover member 6b fixes or secures the coupling member 6c to the stationary portion 1.

The brake assembly 200 of FIGS. 2A-G further differs from the brake assembly 100 of FIGS. 1A-G in that in the brake assembly 200 of FIGS. 2A-G the fasteners 8 extend both through cover member 6a of the coupling assembly 6 and through the flanges 1b of the stationary portion 1, thereby securing both the cover member 6a and the stationary portion 1 to the axle housing 7.

FIGS. 2E-G illustrate how the axial position of the stop member 3 relative to the stationary portion 1 can be altered by moving or screwing the threads of the male threaded portion 40 of the stop member 3 along the threads of the female threaded portion 60 of the coupling member 6c, here given by a nut, in order to adapt the axial position of the stop member 3 relative to the stationary portion 1 to different thicknesses of the brake pack 2.

In FIG. 2E the brake pack 2 includes five stator plates and four rotor plates, and the stop member 3 is disposed at a first axial position relative to the stationary portion 1. In FIG. 1F the brake pack 2 includes four stator plates and three rotor plates, i. e. its axial thickness is reduced with respect to the axial thickness of the brake pack 2 of FIG. 2E, and the stop member 3 is disposed at a second axial position relative to the stationary portion 1, further towards the brake piston 5 than in the first axial position of FIG. 2E. And in FIG. 2G the brake pack 2 includes three stator plates and two rotor plates, i. e. its axial thickness is further reduced with respect to the axial thickness of the brake pack 2 of FIG. 2F, and the stop member 3 is disposed at a third axial position relative to the stationary portion 1, still further towards the brake piston 5 than in the second axial position of FIG. 2F.

All of the figures are drawn to scale, although other relative dimensions may be used. Further, the figures show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example

1. A brake assembly, comprising:
a stationary portion forming a hollow for receiving a brake pack therein, and
a stop member partially received in or configured to be partially received in the hollow along an axis to form a brake pack stop,
wherein the stop member has a plurality of axially spaced coupling features for selectively coupling the stop member to the stationary portion at either one of two or more different axial positions of the stop member relative to the stationary portion.

2. The brake assembly of claim 1, wherein the plurality of coupling features are disposed on a radially outer side of the stop member.

3. The brake assembly of claim 1, wherein the stop member is a sleeve-like member.

4. The brake assembly of claim 1, wherein the stop member is coupled to the stationary portion in a torque proof manner with respect to the axis.

5. The brake assembly of claim 4, wherein the stop member comprises a plurality of radially extending protrusions received in axially extending recesses formed in a radially inner surface of the stationary portion.

6. The brake assembly of claim 5, wherein the radially extending protrusions of the stop member are axially spaced from the coupling features of the stop member.

7. The brake assembly of claim 1, further comprising a brake pack received in the hollow of the stationary portion, the brake pack including one or more stator plates coupled to the stationary portion and one or more rotor plates configured to be coupled to a rotatable shaft.

8. The brake assembly of claim 7, further comprising a brake piston for selectively pressing the brake pack against the stop member along the axis.

9. The brake assembly of claim 1, further comprising a coupling assembly secured to the stationary portion, wherein the stop member is configured to be selectively coupled to the coupling assembly via either one of the plurality of axially spaced coupling features.

10. The brake assembly of claim 9, wherein the coupling assembly includes a cover member secured to the stationary portion, and a coupling member mounted on the cover member, wherein the stop member is configured to be selectively coupled to the coupling member via either one of the plurality of axially spaced coupling features.

11. The brake assembly of claim 10, wherein the coupling member is mounted in a recess (6b) formed on a radially inner side of the cover member.

12. The brake assembly of claim 1, wherein the plurality of axially spaced coupling features of the stop member include a plurality of axially spaced annular grooves formed in a radially outer surface of the stop member.

13. The brake assembly of claim 9, wherein the coupling assembly includes a snap ring configured to be received in either one of the plurality of axially spaced annular grooves of the stop member.

14. The brake assembly of claim 7, wherein the plurality of axially spaced annular grooves are periodically arranged along the axis and a period length of the plurality of axially spaced annular grooves corresponds to a sum of an axial thickness of one of the stator plates and of one of the rotor plates.

15. The brake assembly of claim 1, wherein the plurality of axially spaced coupling features of the stop member include a male threaded portion formed in a radially outer surface of the stop member.

16. The brake assembly of claim 9, wherein the coupling assembly includes a female threaded portion engaged with or configured to be engaged with the male threaded portion of the stop member.

17. The brake assembly of claim 16, wherein the female threaded portion is formed in a radially inner surface of the coupling member.
